(19) United States
(12) Patent Application Publication
(10) Pub. No.: US 2010/0134570 A1
(43) Pub. Date: Jun. 3, 2010

(54) INK REFILL DEVICE AND METHOD

(76) Inventor: Kenneth Yuen, San Gabriel, CA (US)

Correspondence Address: MERCHANT & GOULD PC, P.O. BOX 2903, MINNEAPOLIS, MN, 55402-0903, US

(21) Appl. No.: 12/325,865

(22) Filed: Dec. 1, 2008

(51) Int. Cl. B41J 2/175

(52) U.S. Cl. 347/85

(57) ABSTRACT

This disclosure provides a device and method for refilling ink cartridges. In some embodiments the device and related method are partially automated. In some embodiments the method involves very few manual steps, the use of the device results in very little ink loss, and the device is easy to maintain.

### TECHNICAL FIELD

The present disclosure provides a device for refilling ink cartridges and a related method of refilling ink cartridges.

### BACKGROUND

Ink cartridges have been traditionally single use devices meaning that once they are emptied they are discarded and replaced with a new cartridge. More recently, methods and devices have been developed to refill ink cartridges. For example, see U.S. Pat. No. 6,799,610 titled Method and Apparatus for Refilling an Ink Cartridge; U.S. Pat. No. 6,971,740 titled Ink Cartridge Refill System and Method of Use; U.S. Pat. No. 7,303,267 titled Actuator for Automatic Ink Refill System; and U.S. Pat. No. 7,325,909 titled Automatic Ink Refill System and Methods. Such methods of refilling and reusing ink cartridges can provide cost savings and minimize the environmental impact associated with creating new ink cartridges. Improved methods and devices for refilling ink cartridges are desirable.

### SUMMARY

This disclosure provides a device and method for refilling ink cartridges. In some embodiments the device and related method are partially automated. In some embodiments the method involves very few manual steps, the use of the device results in little ink loss, and the device is easy to maintain.

### BRIEF DESCRIPTION OF THE DRAWINGS

FIG. 1 is a perspective view of a cartridge refill station according to the principles of the present disclosure in a cartridge loading position;

FIG. 2 is a perspective view of the cartridge refill station of FIG. 1 in position wherein the ink cartridge refilling has been initiated;

FIG. 3 is a perspective view of the cartridge refill station of FIG. 1 in a position wherein the ink cartridge refilling is almost complete;

FIG. 4A is a perspective vertical cross-sectional view of the cartridge refilling station in the position shown in FIG. 1;

FIG. 4B is a perspective vertical cross-sectional view of the cartridge refilling station in the position shown in FIG. 2;

FIG. 4C is a perspective vertical cross-sectional view of the cartridge refilling station in the position shown in FIG. 3;

FIG. 5A is an exploded assembly view of the cartridge refilling station of FIG. 1;

FIG. 5B is an enlarged exploded assembly view of a portion of FIG. 5A;

FIGS. 6A-B are cross-sectional views showing positions of the ink needles relative to the ink cartridge;

FIG. 7A is a perspective view of a portion of the ink needle sealing assembly of the cartridge refill station of FIG. 1;

FIG. 7B is a perspective exploded view of FIG. 7A;

FIG. 8A is a perspective view of the ink container of the ink refilling station of FIG. 1;

FIG. 8B is a cross-sectional view of FIG. 8A along lines 8B-8B;

FIG. 9A is a perspective view of the ink cartridge drawer of the ink refilling station of FIG. 1;

FIG. 9B is a top view of FIG. 9A;

FIG. 9C is a cross-sectional view of FIG. 9B along lines 9C-9C;

FIG. 10A is a side view of an ink needle of the ink refilling station of FIG. 1;

FIG. 10B is a cross-sectional view of FIG. 10A along lines 10B-10B;

FIG. 10C is a cross-sectional view of FIG. 10A along lines 10C-10C;

FIG. 11A is a cross-sectional view of a portion of the timing arrangement of the ink refilling station of FIG. 1 in a first position; and

FIG. 11B is a cross-sectional view of a portion of the timing arrangement of the ink refilling station of FIG. 1 in a second position.

### DETAILED DESCRIPTION

The present disclosure provides an ink refill station for refilling ink cartridges. The refill station stores ink in one or more ink chambers. Fill needles extending from the ink chambers are introduced into an ink cartridge for filling. After the ink cartridge is filled with ink, the ink needles are disengaged from the ink cartridge.

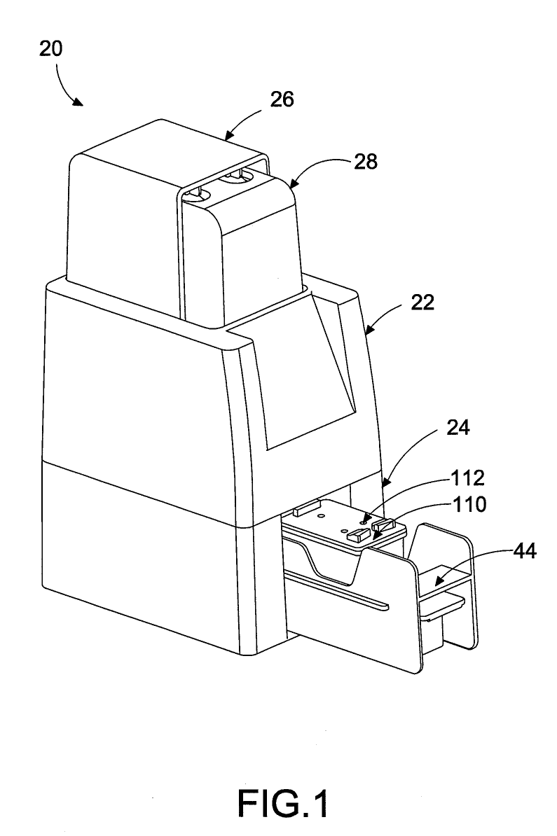

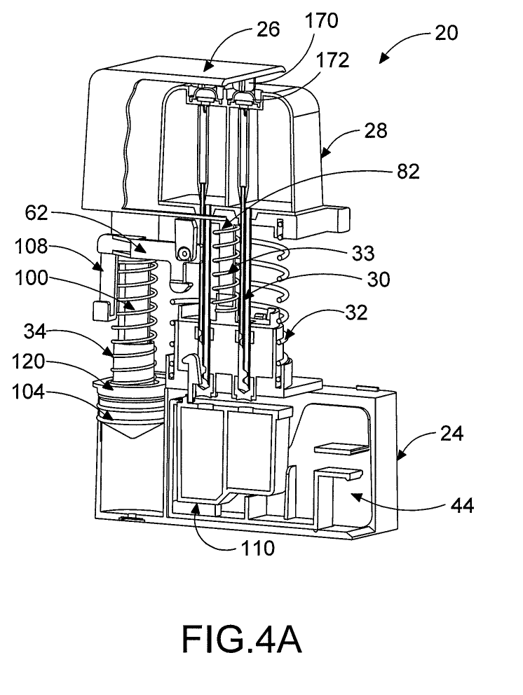

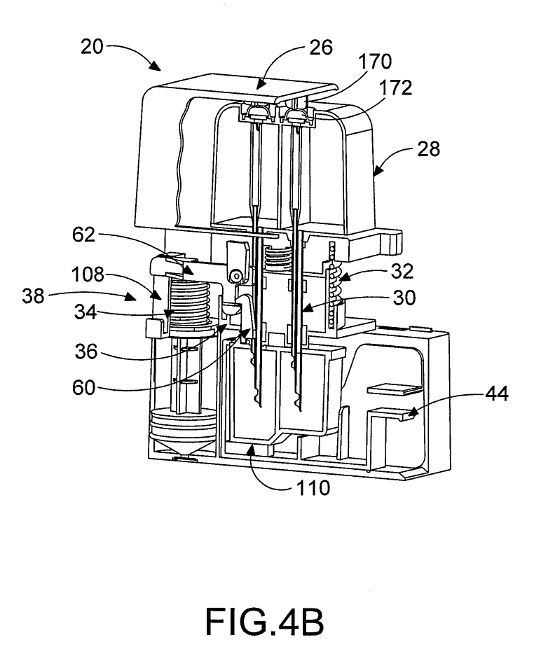

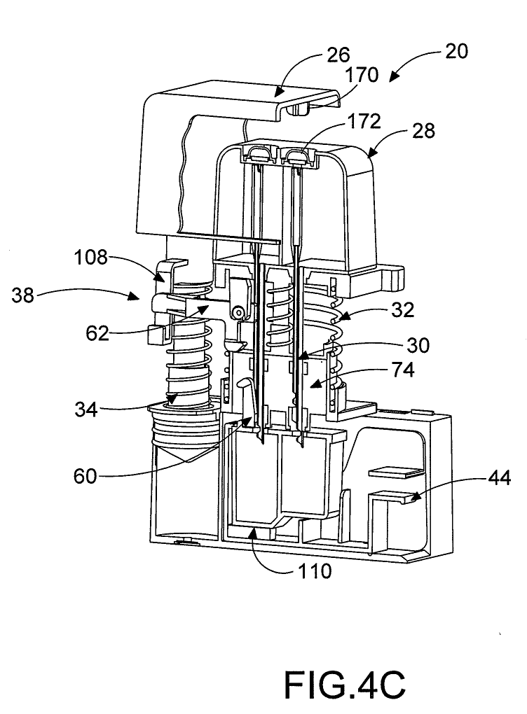

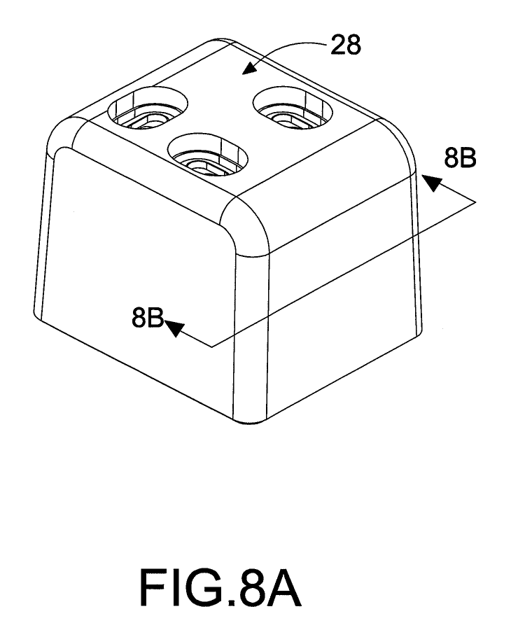

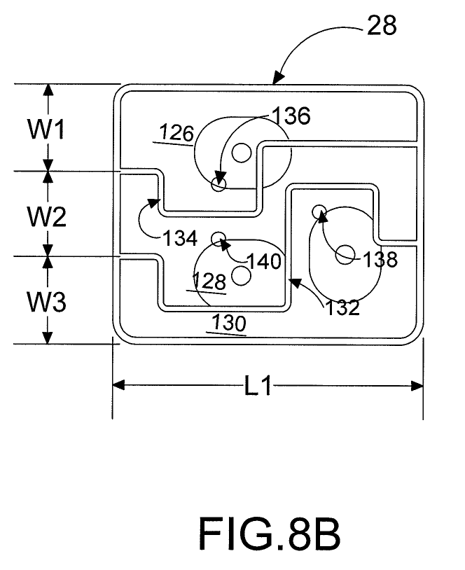

Referring generally to FIGS. 1-6B, an embodiment of an ink cartridge refill station 20 in accordance with the principles of the present disclosure is shown. The ink cartridge refill station 20 is adapted to refill ink cartridge 110. The ink refill station 20 includes a station housing 22 including a base 24, a movable enclosure 26 mounted on top of the base 24, and an ink container 28 defining a plurality of ink reservoirs 126, 128, 130 (FIG. 8B) for storing ink of different colors. The ink refill station 20 also includes a plurality of ink fill needles 30 (see FIGS. 4A-6B and 10A-C). The ink fill needles 30 are each in fluid communication with a respective one of the reservoirs 126, 128, 130 (FIG. 8B) of the ink container 28, and extend downwardly from the ink container toward the base 24. The base 24 is configured to hold the ink cartridge 110 in alignment directly beneath the needles 30. In the depicted embodiment, the ink container 28 is moveable relative to the movable enclosure 26 and also relative to the cartridge 110 (FIGS. 4A-C) secured in a drawer 44 in the base 24.

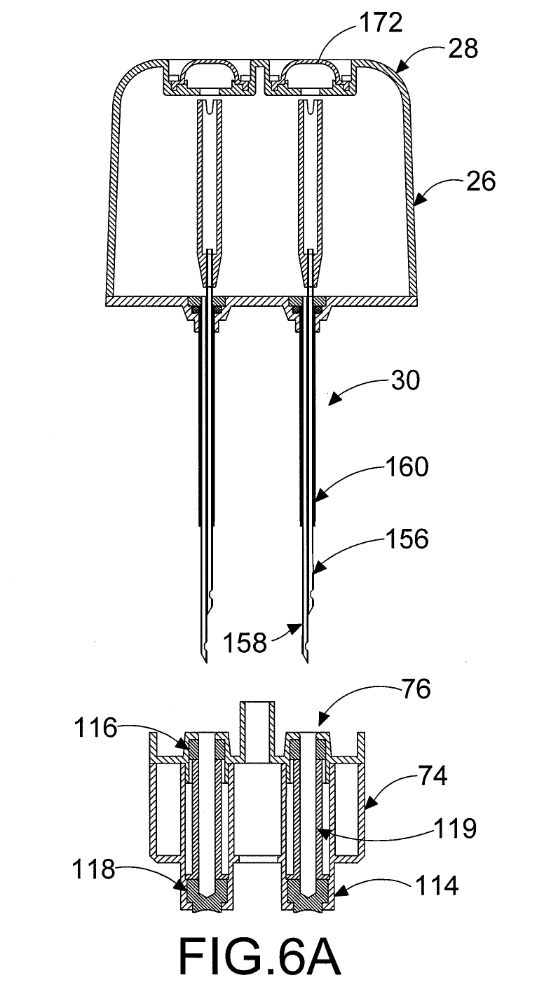

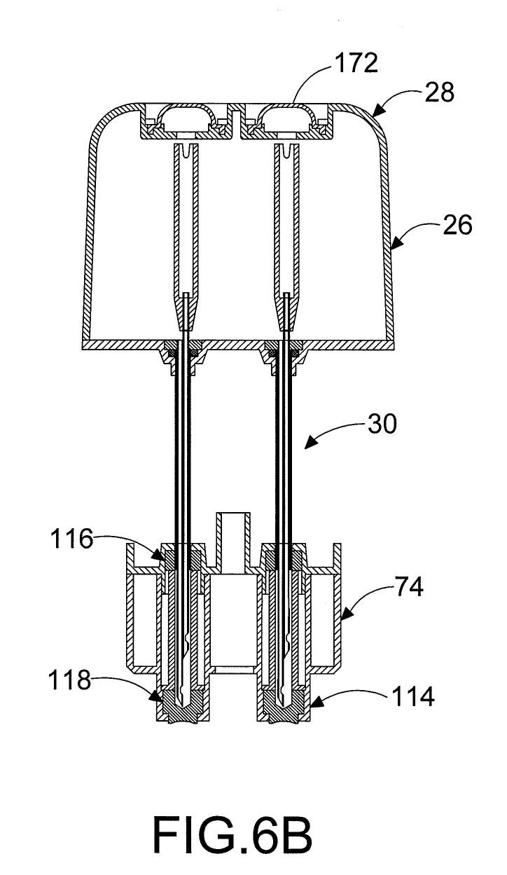

FIG. 1 is a perspective view of the cartridge refill station 20 with the ink container 28 in a cartridge loading position, otherwise referred to herein as the stored position (FIG. 4A is a corresponding cross-sectional view of the refill station in the loading position). The loading or stored position reflects a configuration in which ink cartridges 110 can be loaded and unloaded from the refill station 20 (i.e., typically before filling and after filling). In the depicted embodiment both the enclosure 26 and the ink container 28 are in their up most positions when the refill station is in the stored position (loading position). In this configuration the ink does not flow into the ink cartridge 110 as the lower ends of the ink needles 30 are disengaged from the ink cartridge 110 (FIGS. 4A and 6B) and are positioned within a needle sealing assembly 75 (FIGS. 4A and 6B).

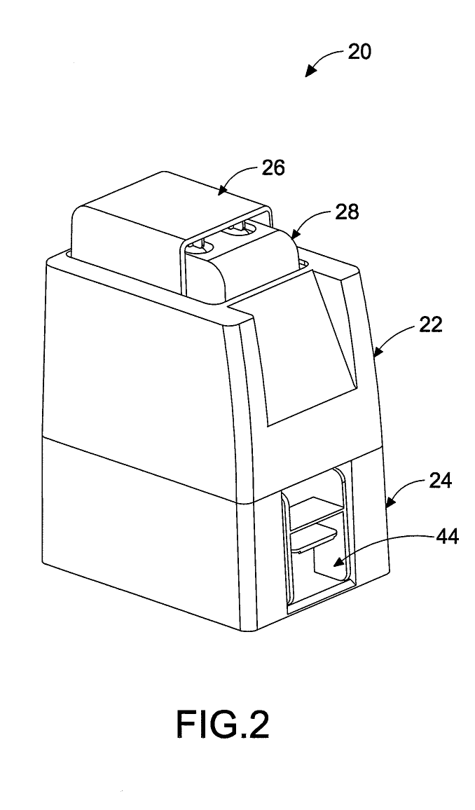

FIG. 2 is a perspective view of the cartridge refill station 20 in position wherein the ink cartridge refilling has been initiated (FIG. 4B is a corresponding cross sectional view of the refill station 20 in the same position). In particular, the movable enclosure 26 and ink container 28 of the refill station are depressed relative to their respective positions in the loading position as shown in FIG. 1. When the refilling is initiated, both the ink container 28 and the enclosure 26 are fully depressed. Ink from the ink container 28 flows into the ink cartridge 110 via the ink needles 30 (see FIGS. 4B and 6B). In the depicted embodiment a latching arrangement 36 is provide that includes first latches 60 fixed relative to the base 24 that engage second latches 62 carried with the ink container 28 to hold the ink container 28 in the refilling position.

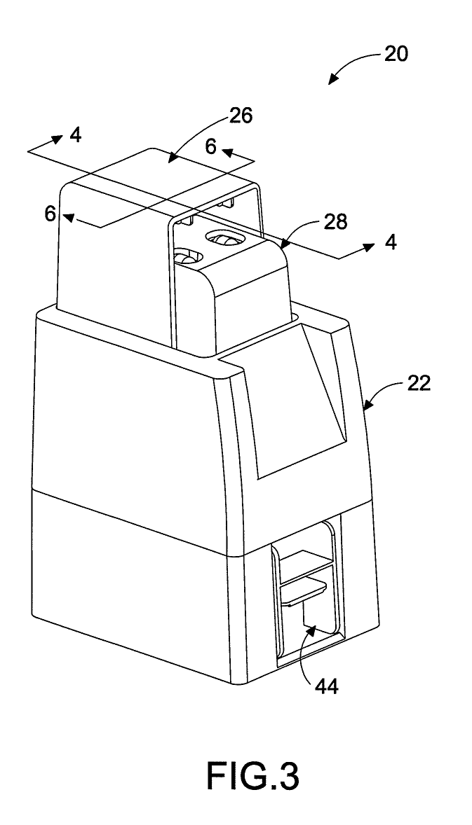

FIG. 3 is a perspective view of the cartridge refill station 20 in a position wherein the ink cartridge refilling is almost complete (FIG. 4C is a corresponding cross-sectional view of the refill station 20 in the same position). In this position the ink container 28 is in the same position it was in FIG. 2 (i.e., fully depressed) and ink continues to flow from the ink container 28 into the ink cartridge 110 via the ink needles 30 (see FIGS. 4C and 6B). The movable enclosure 26 is in an intermediate position between where it is shown in FIGS. 1 and 2. In the depicted embodiment the movable enclosure 26 is part of an ink fill timing system, and gradually moves upward as the ink fills. Once the movable enclosure 26 reaches a certain position, it triggers the disengagement of the ink needles 30 from the ink cartridge 110. In the depicted embodiment a trigger 108 carried with the movable enclosure 26 causing the latches 62 to pivot out of engagement with latches 60, allowing a main return spring 32 to return the ink container 28 back to the stored position.

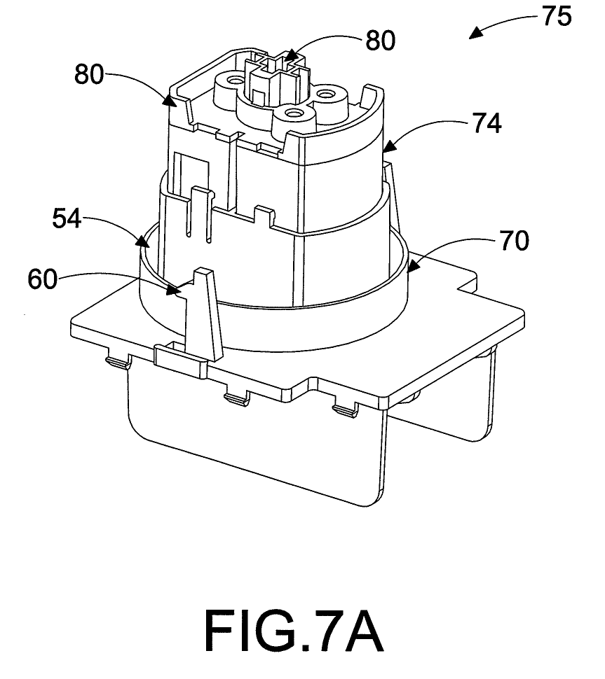

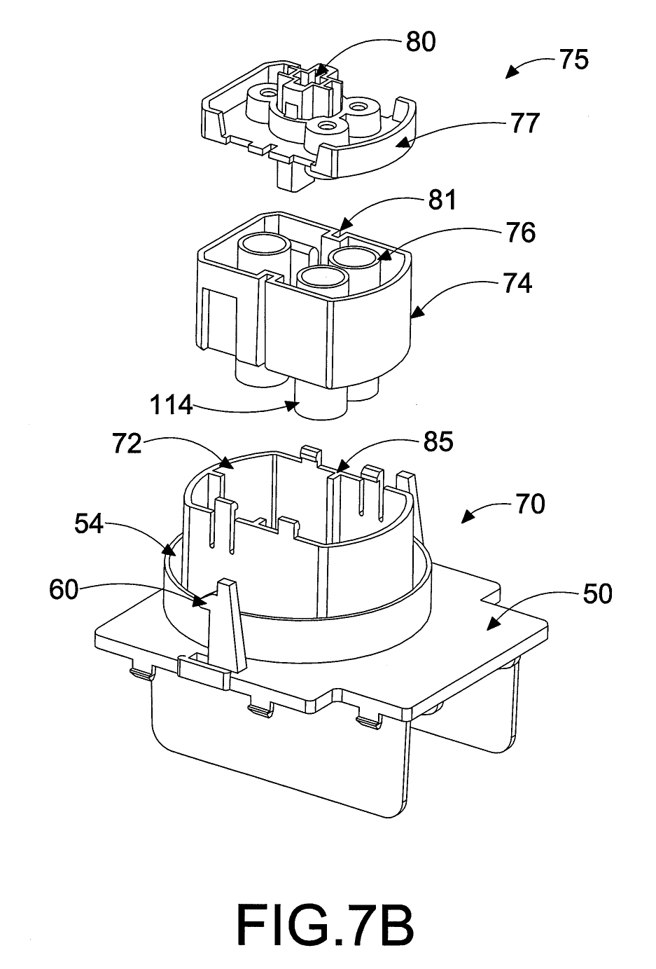

Referring primarily to FIGS. 4A-11B, the components of the refill station 20 are described in greater detail. In the depicted embodiment, one or more springs bias the ink container 28 toward the stored position (loading position). In the depicted embodiment the main return spring 32 is located generally in the center of the refill station 20 is configured and arranged to provide the primary force for moving the ink container towards the stored position. As discussed above, the ink refill station 20 includes a latching arrangement 36 (see the engagement between latches 60 and 62 shown in FIG. 4B) that retains the ink container 28 in the ink refill position while an ink cartridge 110 is being refilled, and a latch release arrangement 38 (see FIG. 4C showing the trigger 108 disengaging the latches 60 and 62) that disengages the latching arrangement 36 after a predetermined amount of time, thereby allowing the spring 32 to return the ink container 28 from the ink refill position of FIGS. 2 and 3 to the storage position (loading position) of FIG. 1.

In use of the ink refill station 20, an ink cartridge 110 that needs to be refilled is inserted into the drawer 44 in the base 24, and refill ports 112 (FIG. 1) of the ink cartridge are aligned below the ink fill needles 30. Once the ink cartridge 110 is in alignment with the ink needles 30, the ink container 28 is manually pressed from the stored position to the ink refill position (from the position shown in FIGS. 1, 4A to the position shown in FIGS. 2, 4B). In the depicted embodiment, manually pressing on the enclosure 26 depresses the ink container 28.

When the ink container 28 moves in the depressed position, ink fill needles 30 which are connected to the ink container 28 also move downwardly (see FIGS. 4B and 6B). As the needles 30 move downwardly, lower tips of the needles extend out of the needle sealing assembly 75 and are received within the refill ports 112 of the ink cartridge 110. The latching arrangement 36 automatically holds the ink container 28 in the refill position. With the ink container 28 in the refill position, the lower tips of the needles 30 are in fluid communication with the inside of the ink cartridge such that ink is free to flow from the ink container 28 through the ink fill needles 30 into the interior of the ink cartridge. Once the ink level in the ink cartridge 110 reaches the lower end of the vent tube 156 (FIGS. 6A-B, 10A) of the needle 30, the flow through the drain tube 158 automatically stops.

After a predetermined amount of time sufficient to allow for all the ink reservoirs 126, 128, 130 (FIG. 8B) of ink cartridge 28 to be completely refilled, the latch release arrangement 38 disengages the latching arrangement 36 and the spring 32 returns the ink container 28 to the stored position. As the ink container 28 moves from the ink refill position to the stored position, the ink fill needles 30 are automatically withdrawn from the ink cartridge 110 and retracted into the ink needle sealing assembly 75. The filled ink cartridge can then be removed from the base 24 via opening the drawer 44.

In the depicted embodiment, the movable enclosure 26 moves upward gradually for a period of time that, as discussed above, is calibrated to correspond to be the time it takes to fill the ink cartridge 1 10. Once the period of time is passed, the movable enclosure 26 causes the ink container 28 to move from the depressed position shown in FIGS. 2 and 3 to the stored position (loading position) shown in FIG. 1. In the depicted embodiment the movable enclosure 26 is part of the latch release arrangement 38. In particular, the upward travel of the movable enclosure 26 cause the latching arrangement 36 to release, unlock, or otherwise disengage.

Referring to FIGS. 4A-C and 6A-B, the ink fill needles 30 of the depicted embodiment have upper ends that are mechanically secured to the ink container 28 such that the ink container 28 and the ink fill needles 30 move together in unison as a unit when the ink container 28 is moved between the stored position and the ink refill position.

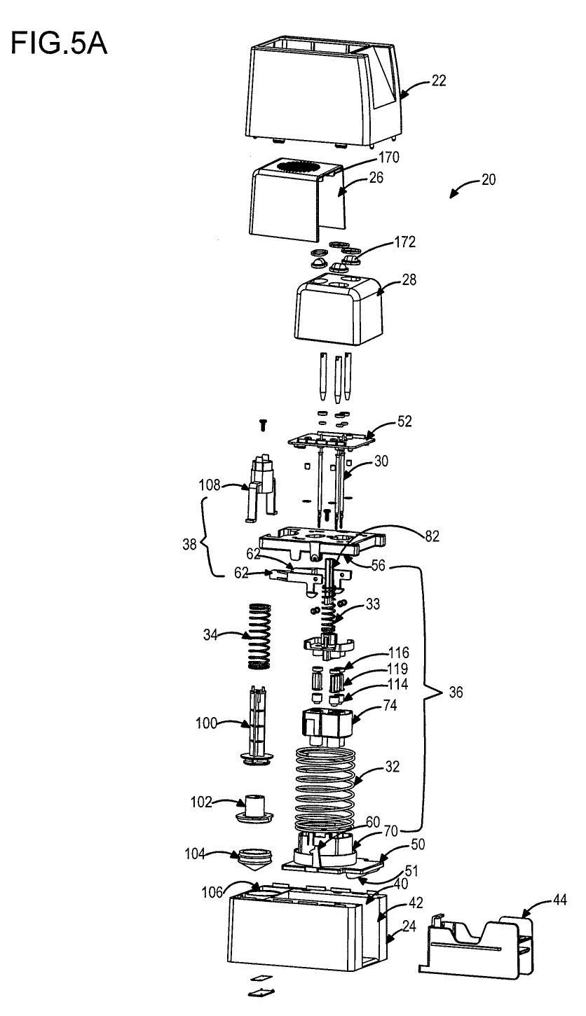

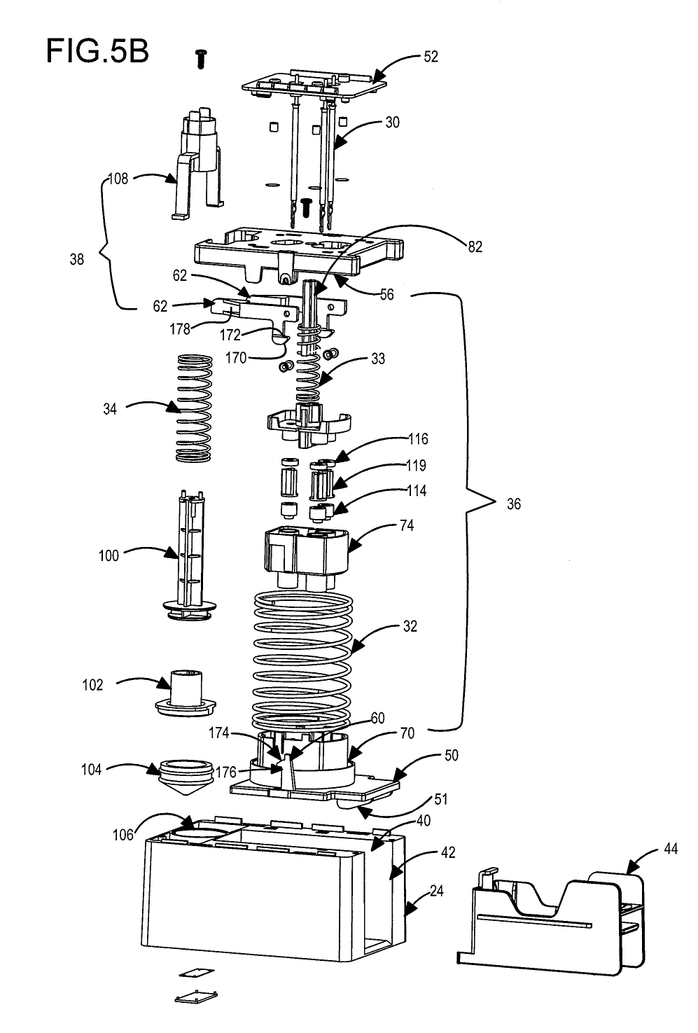

Referring to FIGS. 4A-C and 5A-B, the base 24 of the ink refill station 20 is described in greater detail. In the depicted embodiment the base 24 is generally rectangular and defines an interior compartment 40 positioned beneath the ink fill needles 30. The interior compartment 40 has an open side 42 facing laterally outwardly from one end of the base 24. The interior compartment 40 is sized to slideably receive a drawer 44 sized for receiving an ink cartridge 110 in need of refilling. In use of the ink refill station 20, the drawer 44 is pulled to an open position in which the drawer 44 projects outwardly from the interior compartment 40 (FIGS. 1 and 5A-B). Once the drawer 44 is pulled out, the ink cartridge 110 can be inserted into the drawer 44, and the drawer 44 can be pushed back inside the interior compartment 40. When the drawer 44 is positioned within the interior compartment 40, the refill ports 112 of the ink cartridge 110 preferably align with respective ones of the ink fill needles 30. After the ink cartridge has been refilled, the drawer 44 can be pulled back out from the interior compartment 40, and the filled ink cartridge can be removed from the drawer 44.

Referring to FIGS. 5A-7B, the ink refill station 20 further includes a first platform 50 mounted to a top side of the base 24 (e.g., by a snap-fit connection), and a second platform 56 on which the ink container 28 is mounted. The first platform 50 includes a spring seat 54 that receives a lower end of the spring 32, and the second platform 56 defines a spring seat that receives an upper end of the spring 32. The first platform 50 is fixed relative to the base 24. The second platform 56, the ink container 28, and the ink fill needles 30, together form an ink refill assembly that can move together as a unit upwardly and downwardly relative to the first platform 50, the base 24, and the movable enclosure 26. The second platform 56 fits inside the interior of the housing 22 and supports the base 52 of the ink container 28.

When the ink container is in the stored position, the ink container 28 abuts the enclosure 26. The spring 32 biases the ink refill assembly toward the stored position (FIG. 1). When the ink refill assembly is moved downwardly, the spring 32 compresses between the first and second platforms 50, 56. After an ink cartridge has been refilled and the latch arrangement 36 released, the compressed spring 32 forces the ink refill assembly back to the stored position.

Referring to FIGS. 4A-5B, the latching arrangements 36 and 38 of the ink fill station 20 are shown. In the depicted embodiment the latching arrangement 36 includes first latches 60 connected to the first platform 50 (e.g., integrally connected with the first platform 50 with one on each side of the platform), and second latches 62 pivotally connected to the second platform 56, which are configured to engage the latches 60 on the first platform 50. The latches 62 include angled cam surfaces 170 and catch surfaces 172 (FIG. 5B). Similarly, the first latches 60 include angled cam surfaces 174 and catch surfaces 176. When the ink container 28 is moved down toward the ink refill position (FIGS. 2, 3, 4B, 4C), the cam surfaces 170 of the second latches 62 engage the fixed latch 60, causing the second latches 62 to pivot laterally away from the first latches 60 to allow the catch surfaces of the second latches 62 to move below the catch surfaces 176 of the first latches 60. Once the catch surfaces 172 of the pivoting latches 62 move beneath the catch surfaces 176 of the fixed latches, the second latches 62 pivot back towards the first latches 60 such that the catch surfaces 170 of the second latches 62 are located directly beneath the catch surfaces 176 of the fixed latches, and thereby causing the latches 62, 60 to be interlocked.

Specifically, interference between the catch surfaces prevents the ink refill assembly from moving upwardly relative to the first platform 50. The second latches 62 can include an elongate cantilever arm 178 (FIG. 5B) that extends outwardly from the pivot axes of the pivoting latches and biases the pivoting latches toward the latched orientation via gravity (i.e., the weights of the elongate cantilever arms 178 generate a moment about the pivot axes that biases the pivoting latches 62 toward the latched orientation). It will be appreciated that springs can also be used to bias the pivoting latches toward the latched position.

Referring to FIGS. 5A-7B, the needle sealing arrangement 75 of the ink refill station 20 is shown in greater detail. The first platform 50 includes a central sleeve 70 defining a vertical through-passage. In the depicted embodiment the sealing housing 74 is movable relative to the first platform 50 so that a sealing arrangement 75 abuts the ink cartridge 110, thereby preventing ink leakage when the ink needles 30 are being inserted or withdrawn from the ink cartridge 110. The needle sealing housing 74 is mounted within the through-passage 72 and is slideable within the vertical through-passage 72 between a raised orientation (FIGS. 1, 4A, and 6A) and a lowered orientation (FIGS. 2, 3, 4B, 4C, and 6B). The depicted sealing housing 74 and through-passage 72 include alignment features that allow for sliding, while keeping the needles 30 that extend from the ink container 28 vertically aligned with the ports 112 of the ink cartridge 110. In the depicted embodiment the sealing housing includes vertical channels 81 that receive guide rails 85 extending from the central sleeve 70 that orientate and align the housing 74 with the through-passage 72 of the central sleeve 70. The outer walls of the housing 74 and inner walls of the sleeve 70 also provide alignment.

The needle sealing housing 74 defines a plurality of needle passages 76 that each respectively receives one of the ink fill needles 30. First and second vertically spaced apart seals 116, 118 that are mounted between a fine alignment sleeve 119 within each of the needle passages chamber 76. When the ink refill assembly is in the stored position, the tips of the ink fill needles 30 are positioned between the vertically spaced apart seals 116, 118 such that the seals prevent ink from exiting the needles and leaving the needle sealing housing 74. In the depicted embodiment the lower seals 118 are configured to prevent ink flow therethrough when the needles 30 are retracted past the seal 118. The upper seals 116 are configured to seal against the sleeves 160 of the needles 30. A fine alignment sleeve 119 is positioned within each needle passage chamber 76. The sleeves 119 have lower flanges that precisely fit within the passage chamber 76. The sleeves 119 assist in aligning the needles 30 relative to the sealing housing 74 and, more specifically, relative to the needle passage chambers 76 of the sealing housing.

An upper cap 77 of the needle sealing housing 74 also defines a centrally located vertical guide channel 80 that slideably receives a guide rod 82 having an upper end that is connected to the second platform 56 (FIG. 5B). An upper portion of the guide channel 80 is defined by an attachment hub that projects upwardly from the upper cap 77 of the needle sealing housing 74. In the depicted embodiment, the lower end of the guide rod 82 interlocks with the hub to prevent the lower end of the guide shaft from being vertically withdrawn from the guide channel 80. A spring 33 is mounted around the guide shaft and the hub. The spring 33 has a lower end that fits within a seat defined by the top surface of the needle sealing housing 74, and an upper end that fits within a seat defined by the second platform 56. The needle sealing arrangement 75 is configured and arranged so that the spring 33 biases the sealing housing 74 against the ink cartridge 110 when the ink needles are inserted and removed from the ink cartridge 110 (see FIGS. 4B-C).

The operation of the ink sealing assembly 75 is described in greater detail below. In the depicted embodiment, the needle sealing housing 74 also includes a plurality of lower projections defining ports 114 adapted to align with corresponding ports 112 of the ink cartridge in need of being refilled. The lower seals of the needle sealing housing 74 are preferably located at bottom ends of the projections. When the ink delivery assembly is moved downwardly from the stored position, the needle sealing housing 74 and the needles 30 initially move downwardly together as a unit. Movement of the needle sealing housing 74 with the ink refill assembly is caused by the inner spring that conveys a downward force from the second platform 52 to the top side of the needle sealing housing 74. Downward movement of the ink refill assembly and the needle sealing housing 74 continues, with the needle sealing housing 74 sliding within the central sleeve 70, until the ink delivery projections provided on the bottom side of the needle sealing housing 74 engage the top side of the ink cartridge intended to be refilled. The relationship between the housing 74 and sleeve 70 facilitates alignment. Contact between the ink refill projections and the top side of the ink cartridge prevents further downward movement of the needle sealing housing 74. At this point, downward movement of the needles 30 and the remainder of the ink refill assembly continues such that the needles 30 slide downwardly within the needle passages 76 of the needle sealing housing 74, through the seals 118 located at the bottom ends of the rear ink delivery projections 114, and into the ports of the ink cartridge. Downward movement of the needles through the needle sealing housing 74 is guided by the guide shaft within the second platform 56 within the guide passage of the needle sealing housing 74. Downward movement of the needles 30 relative to the ink sealing housing 74 continues until the tips of the needles are fully within the ink cartridge and the latching arrangement 36 moves to the latched position.

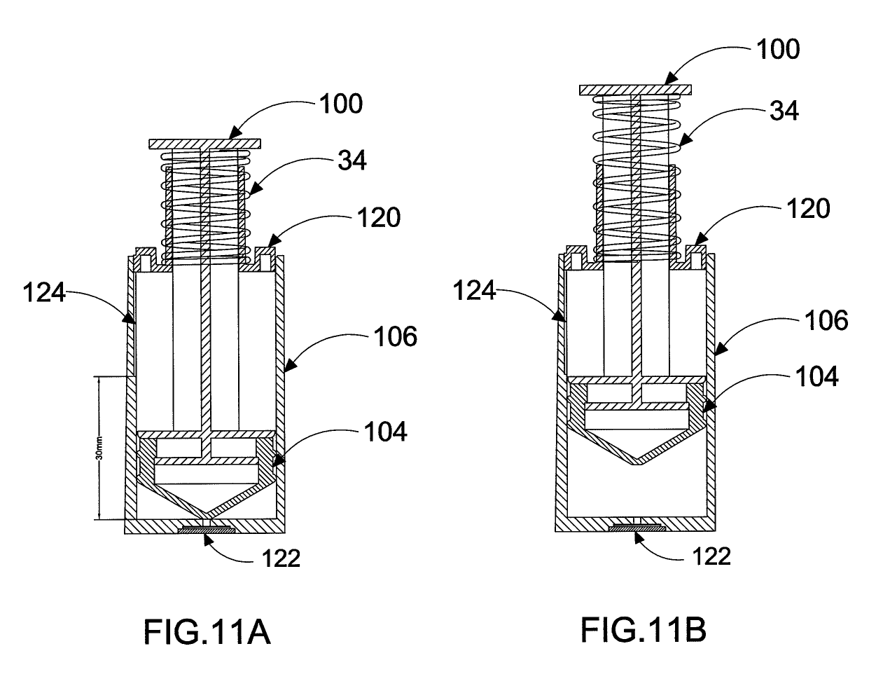

Referring to FIGS. 3, 4C, 5A-B, and 11A-B, the latch release arrangement 38 of the ink refill station 20 is shown. The latch release arrangement 38 includes a piston shaft 100 having an upper end connected to trigger member 108 and a lower end forming a piston head 104. The lower end of the piston shaft 100 is slideably mounted within a piston cylinder 106. The piston head 104 includes a radial seal around its circumference that forms a seal between the piston head 104 and the inner diameter of the piston cylinder 106. The upper end of the shaft 100 is operably connected to the movable enclosure 26. The latch release arrangement 38 also includes release trigger members 108 connected to the piston shaft 100 adjacent the upper end of the piston shaft, and a return spring 34 having an upper end that seats against an underside of the release trigger member and a lower end that seats against a cylinder cap 120 mounted to the base 24 adjacent a top end of the piston cylinder 106. A bottom end of the piston cylinder 106 is closed and includes a bleed valve 122 (FIGS. 11A-B) that allows air to rapidly exit the piston cylinder, but only allows air to slowly enter the cylinder 106 when vacuum is applied to the cylinder 106 via a retraction of the piston head 104. The cylinder 106 is configured such that the piston head 104 retains a tight seal with the piston until a certain height H upon which the seal between the piston head 104 and piston cylinder 106 is broken. In the depicted embodiment, an air groove 124 is provided above the height H in the cylinder 106 for breaking the seal.

In the depicted embodiment the spring 34 and bleed valve 122 are selected or adjusted so that the piston 100 moves from the bottom of the cylinder to the height H in a generally constant amount of time which is correlated to the time it takes to fill an ink cartridge (e.g., 3 minutes). In some embodiments the time that the piston travels from the bottom of the cylinder to the height H is set by selecting a particular spring based on a particular bleed valve and target time. In other embodiments the time that the piston travels is set by changing the height H, the bleed valve 122, and/or characteristics regarding the piston head 104.

The above timing system does not rely on electrical power, however it should be appreciated that electrical components may be employed in timing systems of alternative embodiments of the ink refilling system. In addition to should be appreciated that other non electrical timing system can also be used (e.g., gear driven timer). It should be appreciated that the depicted embodiment provides a timing system that not only indicates to the user when refill is complete, but it also automatically moves the ink needles 30 out of the ink cartridge 110. In alternative embodiments that include timing system, the timing system can be alternatively configured to alert the user that the ink cartridge has been filled (e.g., with a light or a sound), without automatically retracting the needles 30 from the cartridge 110.

Referring back to FIGS. 1-5B, the function and structure of the cap assembly of the ink refill station is shown. In the depicted embodiment the enclosure 26 mounts over a top side of the ink container 28, and includes a top pushing surface positioned over the ink container 28 and side surfaces that at least partially surround sides of the ink container 28. To move the ink container from the stored position (FIG. 1) to the ink refill position (FIGS. 2 and 3), the pushing surface of the cap 102 is pushed downwardly causing the ink refill assembly, the cap 102, the piston shaft 100, and the release trigger member 108 to move downwardly. As the piston shaft 100 moves downwardly within the piston cylinder 106, air is pushed from the cylinder through the bleed valve 122 at the bottom of the cylinder. Upon latching of the latch arrangement 36 (engagement between latches 60 and 62), the latch arrangement 36 holds the ink refill assembly in the ink delivery position.

When the return spring 34 pushes the piston shaft 100 upwards, the attached cap 102 and the release trigger 108 move together as a unit, upwardly relative to the ink container 28. As discussed above, in the depicted embodiment the upward movement is caused by the spring 34 overcoming the resistant of the air pressure within the cylinder 106. Specifically, because the bleed valve 122 only allows air to enter the piston cylinder at a slow rate via vacuum caused by the upward movement of the piston head within the cylinder, the bleed valve 122 prevents the piston head from moving upwardly at a rapid rate. Instead, the return spring causes the piston shaft to move upwardly at a slow rate. This slow upward movement of the piston shaft continues until the piston head reaches a relieve air groove 124 that allows air to rapidly enter the piston chamber 106. Once this occurs, the return spring 34 causes the shaft to move rapidly upwardly. When the piston shaft moves rapidly upwardly, the release trigger 108 engages the cantilever arms of the latch release arrangement 38, causing the latches 62 to pivot from the latched position to a released orientation. Once the pivotal latches move to the released orientation, the main return spring 32 forces the ink refill assembly back to the stored position.

Referring to FIGS. 8A and 8B, the ink container 28 is shown in greater detail. In the depicted embodiment the ink container 28 includes three compartments 126, 128, 130 of generally the same volume which are separated by vertical dividers 132, 134. In the depicted embodiment the ink container 28 includes three ports that connect to three different ink needles 30. The dividers 132 are arranged with a plurality of bends to allow for the ports 136, 138, 140 to be in vertical alignment with the ports 114 of the needle sealing housing 74 and the ports 112 of the ink cartridge 110 (FIGS. 1, 4A, 5A-B, and 6A-B). In the depicted embodiment the widths W1, W2, W3 of the compartments along a front side are generally equal, and the lengths L1 of the compartments are also generally equal. Since the ports are centrally located, the chambers on either side include jogs that extend laterally to enable fluid communication between each of the ports and their respective ink compartment. In the depicted embodiment the ports are located within the middle third of the ink container 28 (within width W2).

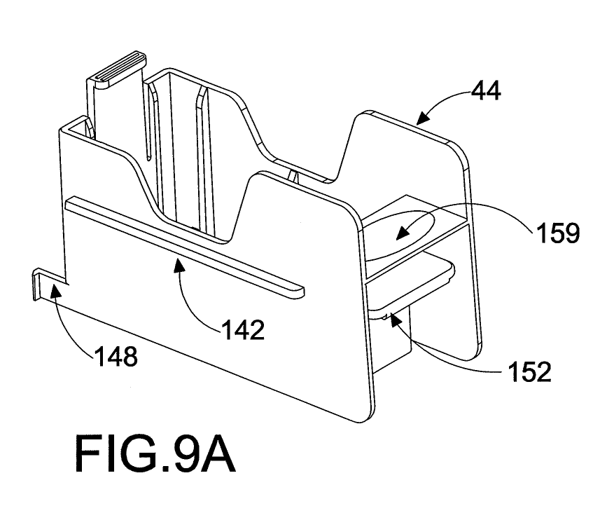

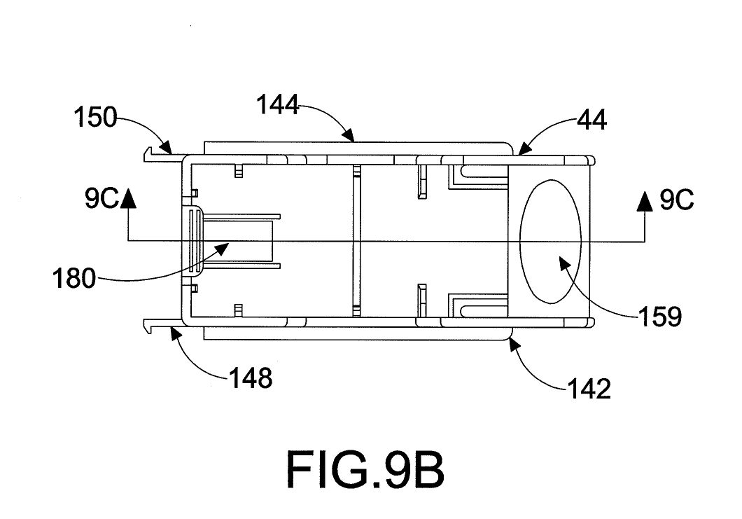

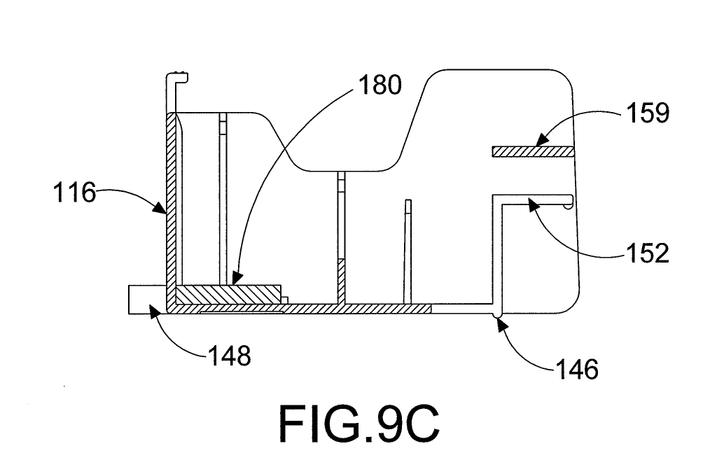

Referring to FIGS. 9A-C, the drawer 44 of the ink refill station 20 is shown in greater detail. In the depicted embodiment, the drawer includes an outer surface with alignment features that align the drawer 44 with the base 24. The features include a pair of side rails 142, 144 that engage channels in the base 24, a bottom ridge 146 that engages a groove in the base 24, and arms 148, 150 that are received in apertures in the base 24. In the depicted embodiment the bottom ridge 146 snaps into the groove in the base upon insertion of the drawer into the base. A grab tab 152 is included for disengaging the bottom ridge 146 from the groove in the base 24 for easy removal. In particular, squeezing the grab tab against the pull tab 159 raises the bottom ridge 146 out of the groove in the base 24. The drawer 44 includes inner surface features that align the ink cartridge 110 with the drawer and secures it therein. In the depicted embodiment, the drawer includes a bottom area for receiving an ink head interfacing member 180 (e.g., absorption pad) that prevents ink from leaking out the ink head of the cartridge 110. The drawer 44 also includes side alignment ridges 142, 144 that engage the sides of the ink cartridge 110. In the depicted embodiment, the lower surface of the first platform 50 include vertical flanges 51 that are configured to press down on the top surface cartridge 110 as the drawer 44 is slid in the base 24, if the user fails to press the cartridge 110 into the drawer. In the depicted embodiment the vertical flanges 51 are ramped shaped so that they gradually press the cartridge 110 downward as the drawer 44 is slid further into the base. The drawer 44 and features of the base 24 (e.g., vertical flanges 51) work together to properly align the cartridge 110 with the ink needles 30.

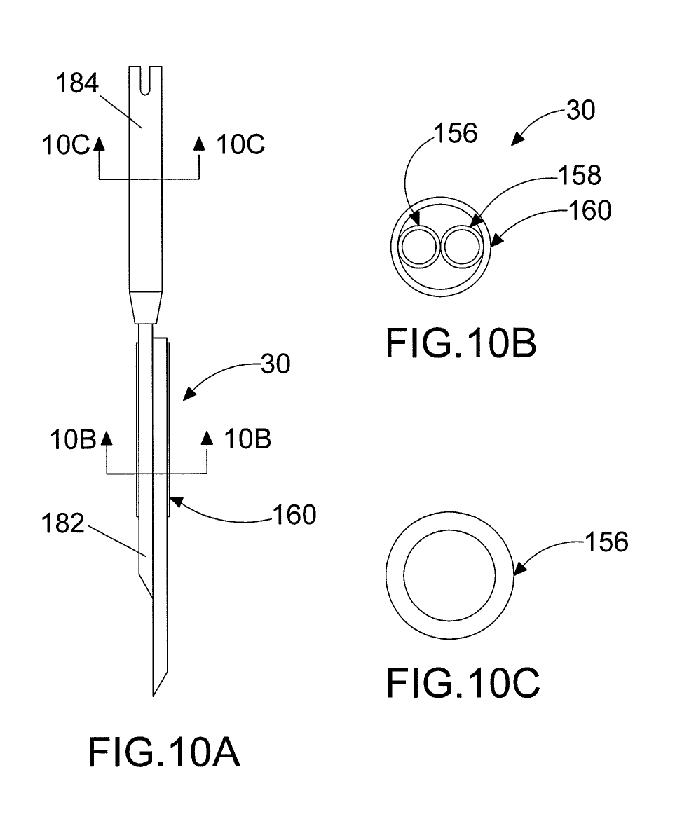

Referring to FIGS. 10A-C, the ink needles 30 are shown in greater detail. In the depicted embodiment the ink needle 30 includes a vent tube 156 and an ink deliver tube (drain tube) 158. The ink delivery tube 158 and the vent tube 156 are configured to extend from the bottom of the ink container 28 into the ink cartridge 110 (FIGS. 6A-B). In the depicted embodiment portions of the ink deliver tube 158 and the vent tube 156 are held within a sleeve 160. The sleeve 160 has generally a circular cross-section, and the drain tube 158 and vent tube 156 have generally circular cross-sections (FIG. 10B).

In the depicted embodiment the cross-sectional area of at least some portion of the vent tube is not equal to the cross-sectional area of the drain tube 158. This configuration can prevent the undesirable stoppage of ink flow that can result from ink flowing into the vent tube. The difference in cross-sectional area facilitates the free flow of ink even if some ink enters the vent tube 156. In the depicted embodiment the cross-sectional area of the vent tube is not constant along its length. In particular, the cross-sectional area of the vent tube 156 is greater at its top end than at its bottom end. In the depicted embodiment, a bottom portion 182 of the vent tube 156 is metal and a top portion 184 of the vent tube 156 is plastic. The top portion is configured be connected to the bottom portion by sliding a lower end of the top portion 184 over the upper end of the bottom portion 182. It should be appreciated that the arrangement and cross-sectional shapes of the vent tube, drain tubes, and sleeve can be different in different embodiments of the needles 30.

In the depicted embodiment, the ink container 28 and the enclosure 26 include an ink pump system that further facilitates ink flow from the ink container 28 to the ink cartridge 110 through the ink needles 30. In the depicted embodiment a diaphragm pump 172 is provided on the upper surface of each of the compartments 126, 128, 130 of the ink container 28. Actuators 170 for the pumps extend from the under surface of the enclosure 26. In the depicted embodiment the actuators 170 are configured and arranged to depress the diaphragm pumps 172 when the user presses downward on the enclosure 26, and the actuators 170 are configured to automatically retract from the diaphragm pumps 172 when the enclosure moves upwards away from the ink cartridge 28. The pumps 172 are made of elastic material that is compressed to a lower volume configuration when engaged by the actuators 170 and automatically elastically expand to a higher volume configuration when disengaged from the actuators 170 thereby causing air from the ink compartments 126, 128, 130 to be drawn into the volume. When the actuators 170 are retracted from the pumps 172, the pumps 172 create a suction force in the ink compartments 126, 128, 130. The suction force (otherwise referred to as a pressure differential or vacuum force) facilitates air flow from the ink cartridge 110 to the ink container 28 through the vent tubes 156 of the ink needles 30, thereby facilitating ink flow through the drain tubes 158 of the ink needles 30. In the depicted embodiment the diaphragm pumps 172 include a rubber diaphragm that is secured to the ink cartridge 28 via gaskets and seals that snap into place on the ink cartridge.

The above specification, examples and data provide a complete description of the manufacture and use of the composition of the invention. Since many embodiments of the invention can be made without departing from the spirit and scope of the invention, the invention resides in the claims hereinafter appended.

We claim:

1. An ink refilling system comprising:
an ink cartridge support area configured to receive at least a portion of an ink cartridge;
an ink container including a plurality of ink delivery needles extending therefrom, wherein the ink delivery needles are arranged to extend towards the ink cartridge support area when the ink container is in an ink delivery position, and retract from the ink cartridge support area when the ink container is out of the ink delivery position; and
an ink delivery needle sealing unit positioned between the ink container and the ink cartridge support area, wherein distal ends of the ink delivery needles are contained within the sealing unit when the ink container is out of the ink delivery position.

2. The ink refilling system of claim 1, further comprising a spring that biases the ink container out of the ink delivery position and a latch assembly that holds the ink container in the ink delivery position against the force of the spring.

3. The ink refilling system of claim 2, further comprising a timing system configured to release the latch assembly that holds the ink container in the ink delivery position after a preset duration in which the ink container is in the ink delivery location.

4. The ink refilling system of claim 3, wherein the timing system includes an air piston housed in a piston cylinder, wherein the piston is driven in a first direction by a spring and its movement is slowed by a vacuumed force in the piston cylinder, wherein the piston is configured such that when it reaches a certain position in the piston cylinder it causes the latch assembly that holds the ink container in the ink delivery position to release.

5. The ink refilling system of claim 3, wherein depressing a portion of the timer sets the timer and simultaneously moves the ink container into the ink delivery position.

6. The ink refilling system of claim 1, wherein the ink delivery needle sealing unit is configured to be pressed against a portion of the ink cartridge when the ink container is in the ink delivery position.

7. The ink refilling system of claim 6, wherein the ink delivery needle sealing unit is configured to movable relative to the ink container and wherein the ink delivery needle sealing unit includes a spring arranged to press the ink delivery needle sealing unit against the portion of the ink cartridge when the ink container is in the ink delivery position.

8. The ink refilling system of claim 7, wherein the ink delivery needle sealing unit includes a plurality of chambers, each including a lower seal and an upper seal, wherein the lower seals are configured to prevent ink from flowing out of the chambers.

9. The ink refilling system of claim 8, further comprising alignment sleeves within each of the chambers to align the ink delivery needles relative to the chambers when the ink container moves relative to the ink delivery needle sealing unit.

10. The ink refilling system of claim 6, wherein the ink delivery needle sealing unit includes alignment features that enable the sealing unit to slide in a vertical direction relative to the ink cartridge support area while maintaining its position relative to the ink container.

11. The ink refilling system of claim 10, wherein the alignment features include a housing that supports a plurality of ink chambers and a sleeve that movably supports the housing and configured to allow the housing to slide relative to the ink container.

12. The ink refilling system of claim 11, wherein the housing and sleeve include a rail and groove arrangement.

13. The ink refilling system of claim 1, wherein the ink cartridge support area includes a drawer that slides into alignment with the ink delivery needles, wherein the drawer includes an ink pad configured and arranged to prevent the ink cartridge from leaking ink during refilling.

14. The ink refilling system of claim 1, wherein the ink cartridge support area includes a drawer that slides into alignment with the ink delivery needles, and flanges that press the ink cartridge down into the drawer as the drawer is slid into alignment with the ink delivery needles.

15. A device for providing ink to an ink cartridge comprising:
an ink cartridge support area configured to receive at least a portion of an ink cartridge;
an ink container connected to the ink cartridge support area, the ink container including multiple chambers for housing different colors of ink, wherein the ink container can be manually lowered from a cartridge loading position and locked in an ink delivery position, and wherein the ink container is configured to automatically raise from the ink delivery position back to the cartridge loading position, wherein each of the chambers in the ink container includes substantially the same volume;
a plurality if ink delivery needles, wherein each of the chambers includes at least one ink delivery needle extended therefrom and wherein the ink delivery needles are configured to extend into an ink cartridge in the ink cartridge support area when the ink container is in the ink delivery position, and retract from the ink cartridge when the ink container is in the cartridge loading position;
an ink delivery needle sealing unit positioned between the ink container and the ink cartridge support area, wherein distal ends of the ink delivery needles are contained within the sealing unit when the ink container is out of the ink delivery position; and
a timing assembly for releasing the ink container from the ink delivery position after a preset period of time.

16. The ink refilling system of claim 15, wherein at least one of the ink delivery needles includes a vent tube and an ink delivery tube, wherein at least a portion of the ink delivery tube has a different cross-sectional area than at least a portion of the vent tube.

17. The ink refilling system of claim 16, wherein the vent tube has a larger cross-sectional area at an upper end as compared to a lower end.

18. The ink refilling system of claim 15, wherein the ink delivery needle sealing unit includes a plurality of chambers, each including a lower seal and an upper seal, wherein the lower seal is configured to prevent ink from flowing out of the chamber when an end of the ink delivery needle is in the chamber.

19. The ink refilling system of claim 15, further comprising a plurality of diaphragm pumps that are configured and arranged to facilitate ink flow through the ink delivery needles.

20. The ink refilling system of claim 15, wherein the timing assembly includes a spring-driven air piston assembly and wherein the timing assembly includes a portion that when lowered also lowers the ink container from the stored position to the ink delivery position.

21. A method of refilling an ink cartridge comprising:
positioning an ink cartridge in an ink refill station;
moving a portion of the ink refilling station from a first position to a second position, thereby simultaneously initiating ink flow from an ink container into the ink cartridge and resetting a timer; and
removing the filled ink cartridge after the portion of the ink refill station automatically moves from the second position back to the first position.

22. The method of claim 21, wherein the step of moving a portion of the ink refilling station from the first position to the second position results in lowering an ink container towards an ink cartridge positioned below the ink container.

23. The method of claim 21, wherein a centrally mounted spring is used to automatically move the portion of the ink refill station from the second position back to the first position.

24. The method of claim 21, further comprising minimizing ink leakage by simultaneously moving ink delivery needles into an ink sealing unit when the needles are retracted from the ink cartridge.

25. The method of claim 21, wherein the refilling is accomplished without the use of internal or external sources of electrical power.

26. The method of claim 21, wherein the step of positioning an ink cartridge in a refill station includes placing an ink cartridge in an ink cartridge support member and sliding the support member into engagement with a base member.

27. The method of claim 26, wherein the step of removing the filled ink cartridge includes lifting a tab on the ink cartridge support member and pulling the ink cartridge support member from the base.
